(19) United States
(12) Patent Application Publication
(10) Pub. No.: US 2011/0033070 A1
(43) Pub. Date: Feb. 10, 2011

(54) SOUND IMAGE LOCALIZATION PROCESSING APPARATUS AND OTHERS

(75) Inventors: Kensaku Obata, Tsurugashima-shi (JP); Yoshiki Ohta, Tsurugashima-shi (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION, Meguro-ku, Tokyo (JP)

(21) Appl. No.: 12/446,361

(22) PCT Filed: Oct. 25, 2006
(86) PCT No.: PCT/JP2006/321242

§ 371 Date: Apr. 20, 2009

(51) Int. Cl. H04R 5/02

(52) U.S. Cl. 381/303

(57) ABSTRACT

A sound image localization processing apparatus is provided, in which a surround system is realized by a front speaker with a simple signal process, and the same side localization effect can be given to a plurality of listeners.

A sound image localization processing apparatus 100 causes two speakers FR, FL disposed at the right and the left in front of a listener to output sound in accordance with a plurality of supplied sound signals, and gives a sound space with a sense of realism to the listeners.

The apparatus 100 comprises:
signal processing means 200 for controlling a phase of a right signal indicative of sound signal which should be heard from the right side, and a left signal indicative of sound signal which should be heard from the left side, relative to a listening position of one of the listeners, and localizing a sound image at a side of one of the listeners
frequency-band division means 200 for dividing the processed sound signal by a predetermined frequency band, and
signal correction means 200 for assigning each listener to the divided frequency band, controlling a phase of the right signal or the left signal which has been signal-processed for a listening position of the other listener, and localizing a sound image at a side of the other listener.

### TECHNICAL FIELD

The present invention relates to a technical field of sound image localization process of changing the position of sound image and reproducing sound, and in particular, a technical field of sound image localization process for a plurality of listeners.

### BACKGROUND ART

Generally, a surround system called a 5.1 ch surround system is put to practical use. The surround system is arranged to comprise a center speaker disposed in front of a listener, front speakers disposed on the left and right sides thereof, a rear speaker disposed on the left and right sides or the rear side of the listener and functioning as a surround speaker, and a sub-woofer only reproducing a low frequency. The surround system changes the position of sound image for a listener, for example, by delay-controlling a sound signal to be supplied to each speaker, so that the listener can obtain a side localization effect in which a sound image is localized on a side.

On the other hand, recently, a technology exists in which it is possible to change the position of sound image for a listener by only front speakers disposed on the left and right sides in front of the listener without using a surround speaker (a rear speaker) (for example, see Patent Document No. 1).

A surround system disclosed in Patent Document No. 1 has the following arrangement. In a 5.1 ch surround system, after left and right surround signals (sound signals) to be supplied to a surround speaker disposed on the left and right sides or the rear side of a listener are mixed with each other, the mixed signal is divided into two signals as monaural signals by a signal processing, and one monaural signal is supplied to a center speaker, and the other monaural signal is supplied to left and right front speakers.

Patent Document No. 1: Japanese Patent Application No. 2000-577859

### DISCLOSURE OF THE INVENTION

### Problems to be Solved by the Invention

In the above-mentioned surround system, however, a surround system is realized by using a filtering process with a transfer function. An amount of calculation is large in a process in which a transfer function to both ears is used, and in the case where a reproduction process is performed for listeners taking a plurality of seats, it is necessary to prepare such filtering process for each seat one-by-one, and it is unsuitable for a tuning process at the time of change of target seat. Thus, there are many problems in practical use.

Further, in the above-mentioned surround system, both surround signals are converted to monaural signals once, so it is not possible to reproduce the localization of surround signal in a manner of original signal.

Furthermore, in a surround system in which it is possible to obtain a side localization effect by a general front speaker only, in the case where there exist a plurality of listeners, although a listener taking a center seat obtains a side localization effect in which a sound image is localized at a side, an area in which a listener can experience such effect is narrow, and another listener cannot experience such effect sufficiently. This is a problem.

The present invention has been accomplished in consideration of the above problems, and it is an object of the invention to provide a sound image localization processing apparatus in which a surround system is realized by a front speaker with a simple signal process, and a plurality of listeners can obtain the same side localization effect.

### Means for Solving the Problems

In order to solve the above-mentioned problems, the invention of claim 1 relates to a sound image localization processing apparatus (100), which causes two speakers (FL, FR) disposed at the right and the left in front of a listener to output sound in accordance with a plurality of supplied sound signals, and localizes a sound image at a side of a plurality of listeners,

the sound image localization processing apparatus, comprises:

signal processing means (200) for controlling a phase of a right signal indicative of sound signal which should be heard from the right side, and a left signal indicative of sound signal which should be heard from the left side, relative to a listening position of one of the listeners, and localizing a sound image at a side of one of the listeners

frequency-band division means (200) for dividing the processed sound signal by a predetermined frequency band, and

signal correction means (200) for assigning each listener to the divided frequency band, controlling a phase of the right signal or the left signal which has been signal-processed for a listening position of the other listener, and localizing a sound image at a side of the other listener.

Further, the invention of claim 4 relates to a sound image localization processing method, of causing two speakers disposed at the right and the left in front of a listener to output sound in accordance with a plurality of supplied sound signals, and localizing a sound image at a side of a plurality of listeners,

the sound image localization processing method, comprises:

a signal processing process of controlling a phase of a right signal indicative of sound signal which should be heard from the right side, and a left signal indicative of sound signal which should be heard from the left side, relative to a listening position of one of the listeners, and localizing a sound image at a side of one of the listeners

a frequency-band division process of dividing the processed sound signal by a predetermined frequency band, and

a signal correction process of assigning each listener to the divided frequency band, controlling a phase of the right signal or the left signal which has been signal-processed for a listening position of the other listener, and localizing a sound image at a side of the other listener.

Furthermore, the invention of claim 5 relates to a sound image localization processing program which causes a computer included in a sound image localization processing apparatus according to any of claims 1 to 3 to function as:

signal processing means for controlling a phase of a right signal indicative of sound signal which should be heard from the right side, and a left signal indicative of sound signal which should be heard from the left side, relative to a listening position of one of the listeners, and localizing a sound image at a side of one of the listeners

frequency-band division means for dividing the processed sound signal by a predetermined frequency band, and

signal correction means for assigning each listener to the divided frequency band, controlling a phase of the right signal or the left signal which has been signal-processed for a listening position of the other listener, and localizing a sound image at a side of the other listener.

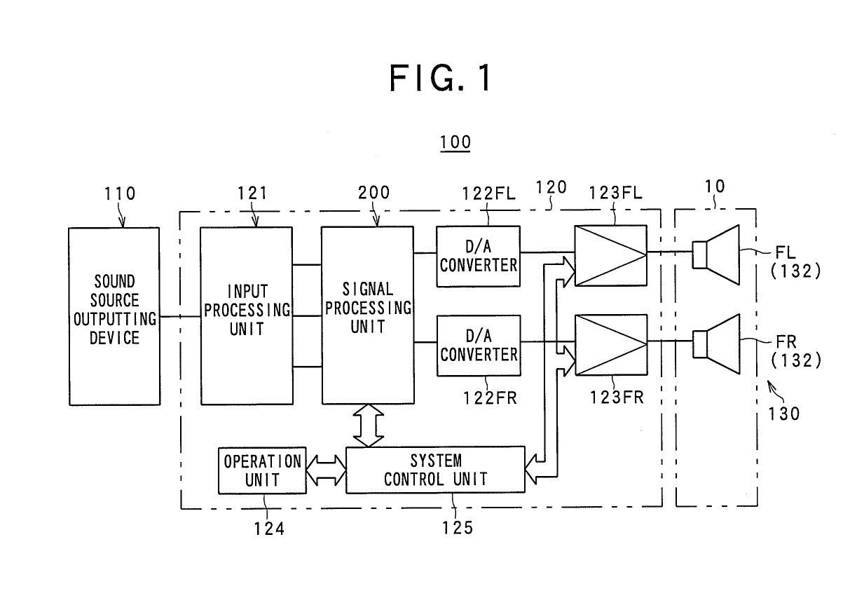

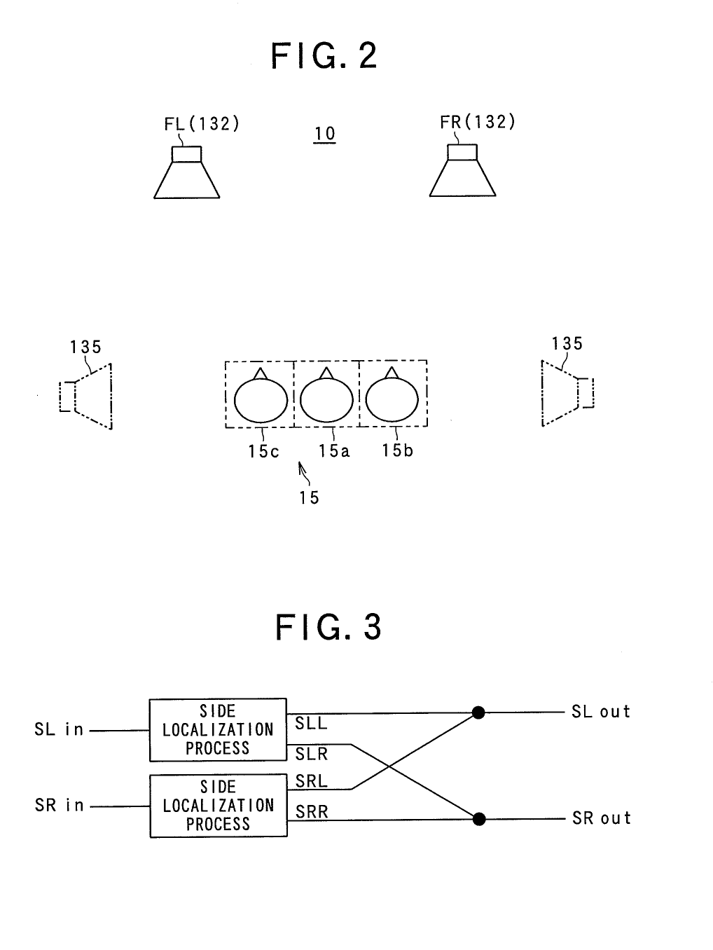

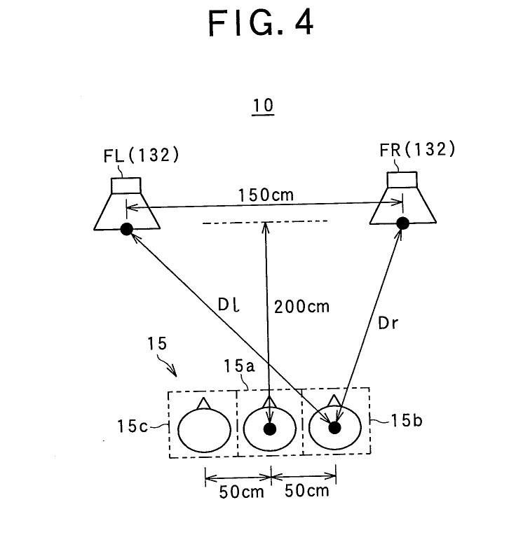

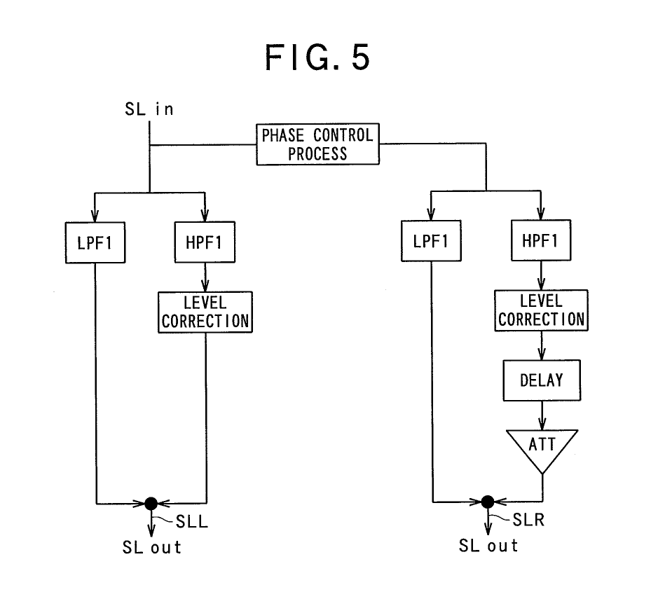

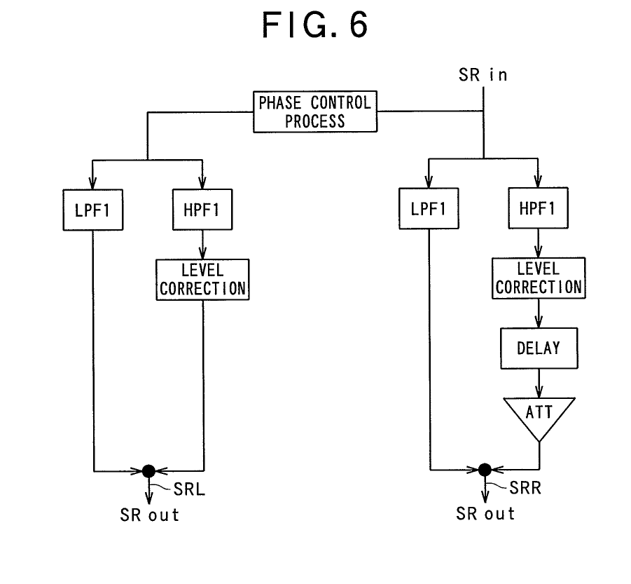

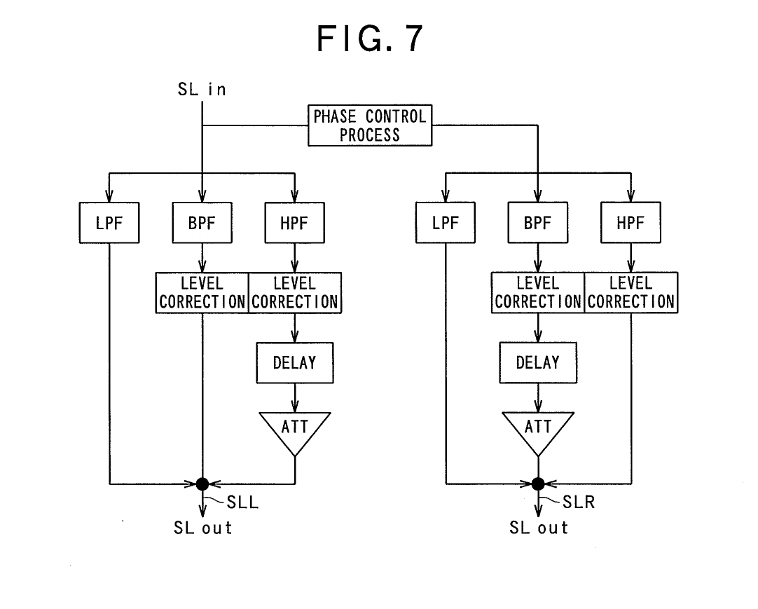

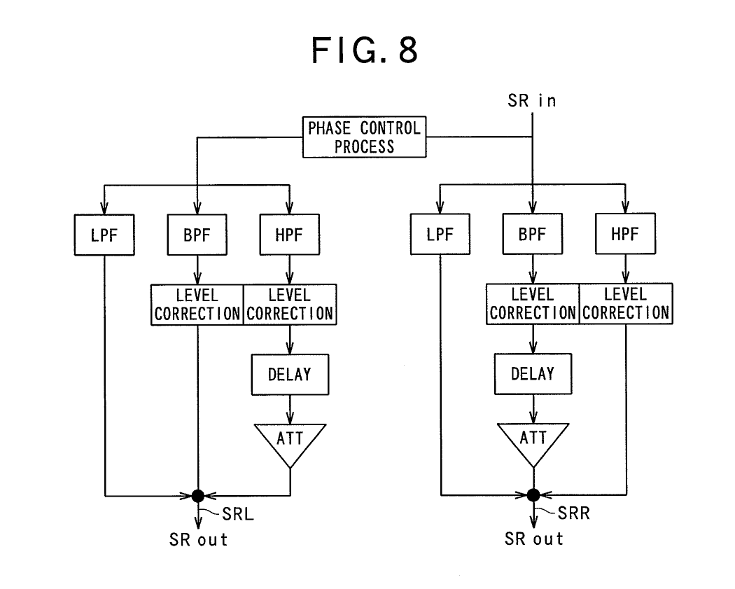

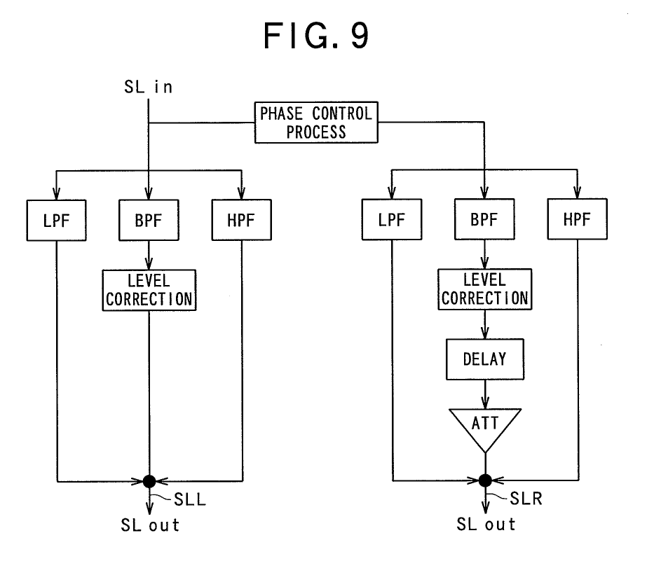

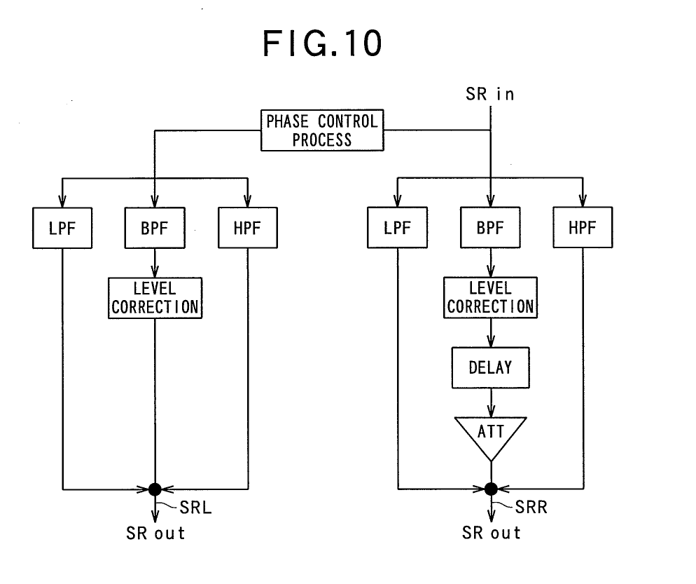

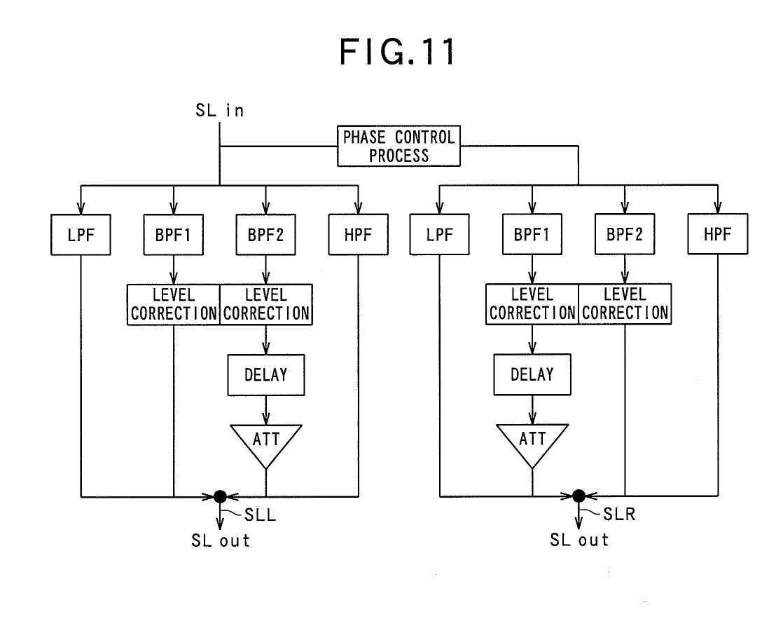

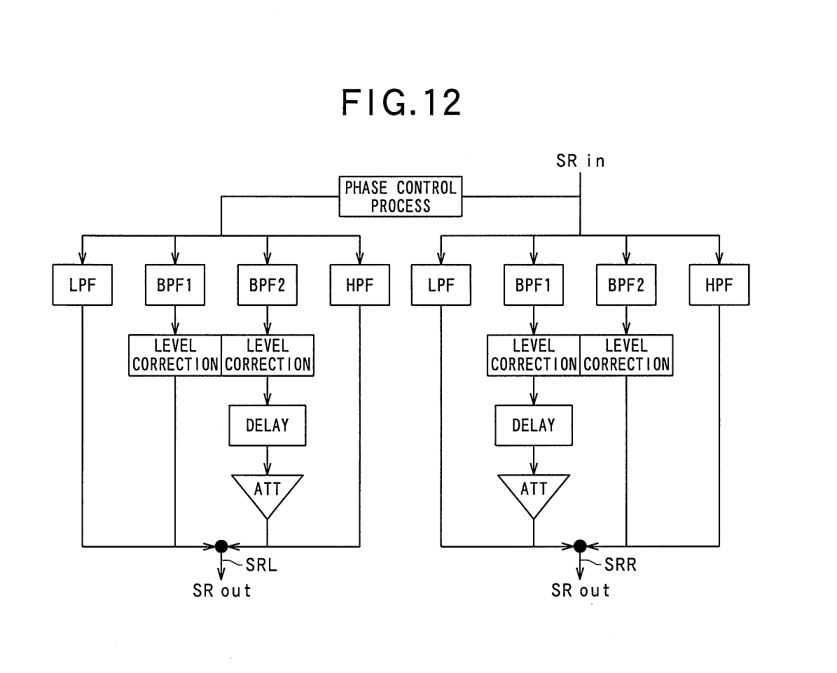

### BRIEF DESCRIPTION OF THE DRAWINGS

[FIG. 1] FIG. 1 is a block diagram showing an arrangement of a surround system according to an embodiment of the invention.

[FIG. 2] FIG. 2 is a view showing an example explaining the relationship between an arrangement of each speaker and a seat position of a listener.

[FIG. 3] FIG. 3 is a view explaining a side localization process in a signal processing unit.

[FIG. 4] FIG. 4 is an example showing the relationship between a position where a speaker is disposed and a seat position of a listener.

[FIG. 5] FIG. 5 is a diagram showing a flow of a surround signal to be supplied to a left speaker in a signal processing unit according to an embodiment No. 1.

[FIG. 6] FIG. 6 is a diagram showing a flow of a surround signal to be supplied to a right speaker in a signal processing unit according to an embodiment No. 1.

[FIG. 7] FIG. 7 is a diagram showing a flow of a surround signal to be supplied to a left speaker in a signal processing unit according to an embodiment No. 2.

[FIG. 8] FIG. 8 is a diagram showing a flow of a surround signal to be supplied to a right speaker in a signal processing unit according to an embodiment No. 2.

[FIG. 9] FIG. 9 is a diagram showing a flow of a surround signal to be supplied to a left speaker in a signal processing unit according to an embodiment No. 3.

[FIG. 10] FIG. 10 is a diagram showing a flow of a surround signal to be supplied to a right speaker in a signal processing unit according to an embodiment No. 3.

[FIG. 11] FIG. 11 is a diagram showing a flow of a surround signal to be supplied to a left speaker in a signal processing unit according to an embodiment No. 4.

[FIG. 12] FIG. 12 is a diagram showing a flow of a surround signal to be supplied to a right speaker in a signal processing unit according to an embodiment No. 4.

### EXPLANATION OF REFERENCE NUMERALS

10 listening room
15 seat
100 sound image localization processing apparatus
132 front speaker
FL left-side front speaker
FR right-side front speaker
200 signal processing unit

### BEST MODE FOR CARRYING OUT THE INVENTION

Referring now to the attached drawings, an embodiment of the present invention will be described. A sound image localization processing apparatus 100 according to the embodiment is an apparatus which uses two front speakers 132 disposed on the left and right sides in front of a listener, and localizes a sound image on the sides of a plurality of listeners.

FIG. 1 is a block diagram showing an arrangement of a sound image localization processing apparatus according to the embodiment. FIG. 2 is a view showing an example explaining the relationship between an arrangement of each speaker and a seat position of a listener in a sound image localization processing apparatus according to the embodiment. FIG. 3 is a view explaining a side localization process in a signal processing unit.

As shown in FIGS. 1 and 2, a sound image localization processing apparatus 100 according to the embodiment is set in a listening room 10, i.e., in a space of sound field which provides a reproduced sound to a listener. As shown in FIG. 1, the sound image localization processing apparatus 100 is arranged to comprise a sound source outputting device 110 which outputs a sound signal corresponding to a channel corresponding to each speaker by reproducing a sound source such as a recording medium, or by acquiring a sound source from the outside such as a television signal, a signal processing device 120 which performs a signal process for a sound signal corresponding to each of a plurality of channels outputted from the sound source outputting device 110, and a speaker system 130 to which a sound signal in which a signal process has been performed for each channel is supplied.

As shown in FIG. 2, in the listening room 10, front speakers 132 are disposed as a speaker system 130. The front speakers 132 are arranged to comprise a front-right front speaker FR (hereinafter, referred to as “FR speaker”), and a front-left front speaker FL (hereinafter, referred to as “FL speaker”) as seen from a listener side. The front speakers 132 are placed side-by-side by a predetermined space. A seat 15 which a listener takes is provided in front of the output side of the speakers 132. The seat 15 comprises, for example, a center seat 15a which is disposed in such a manner that a distance to an FL speaker and a distance to an FR speaker are set equal to each other, and a right seat 15b and a left seat 15c which are disposed on both sides thereof.

The sound image localization processing apparatus 100 causes the front speakers 132 to produce a phenomenon in which it appears as if a listener listens from the sides thereof, by reproducing the difference in a sound pressure level between both ears of a listener by sound outputted from a speaker called a surround speaker 135 on the side or the rear of a listener.

For example, in the case where a side localization effect which localizes a sound image at the side of a listener is given to the listener at the center seat 15a, the sound image localization processing apparatus 100 causes a signal processing unit 200 in the signal processing device 120 to produce a control signal for controlling a phase of surround signal to be supplied to the surround speaker 135, add the control signal to the surround signal, and supply the resultant to the front speaker 132, in order to reproduce the difference between sound pressure levels produced at both ears of a listener by sound produced by the surround speaker 135.

In the case where a listener has moved from the center seat 15a to the right seat 15b, the listener approaches the FR speaker, and moves away from the FL speaker, and a level of sound heard by a right ear becomes greater than that heard by a left ear in the sense of hearing. Therefore, the sound image localization processing apparatus 100 causes the signal processing unit 200 in the signal processing device 120 to delay a sound signal to be outputted from the FR speaker by a predetermined period of time, produce a control signal for attenuating a sound level, and add the control signal to a sound signal and supply the resultant to the front speaker. Thus, a condition where sound is heard at the right seat 15b is equivalent to a condition where sound is heard at the center seat 15a.

On the other hand, in the case where a listener has moved from the center seat 15a to the left seat 15c, it is sufficient that a process in contrast to a process performed in the case where a listener has moved from the center seat 15a to the right seat 15b is performed. That is, the sound image localization processing apparatus 100 causes the signal processing unit 200 in the signal processing device 120 to delay a sound signal to be outputted from the FL speaker by a predetermined period of time, produce a control signal for attenuating a sound level, and add the control signal to a sound signal and supply the resultant to the front speaker. Thus, a condition where sound is heard at the left seat 15c is equivalent to a condition where sound is heard at the center seat 15a.

However, an area where a side localization effect can be experienced is narrow, so it is difficult to make a plurality of persons (for example, a listener at each of a center seat, a right seat, and a left seat) experience such effect simultaneously.

Now, a case will be described, where a listener exists at each of a center seat, a right seat, and a left seat, and a side localization effect is given to each listener.

As mentioned above, when a side localization effect is intended to be given to a plurality of listeners simultaneously by adding control signals produced to localize a sound image at a side of listener at each seat, the control signals interfere with each other, and a phase of sound signal outputted from the front speaker 132 changes. Therefore, usually, the difference in a level of sound pressure cannot be produced for a listener at any seat, so it is not possible to give a sufficient side localization effect to each listener.

Therefore, as shown in FIG. 3, the sound image localization processing apparatus 100 according to the present embodiment causes a sound signal (a surround signal) to be supplied to the right and left surround speakers 135 to be processed for side localization and be outputted so that a sound image is localized at a side of each listener. More specifically, the sound image localization processing apparatus 100 causes the signal processing unit 200 in the signal processing device 120 to divide a surround signal to be supplied to the right and left surround speakers 135 by a predetermined band, assign a plurality of listeners to the bands, respectively, produce a control signal for controlling a phase of surround signal so that each listener can obtain a side localization effect for each band, and add the control signal to a surround signal and output the resultant. Incidentally, a surround signal to which the control signal has been added is supplied to the front speaker 132.

According to the sound image localization processing apparatus 100, a control signal is added to each band of surround signal, so the control signals are not interfered with each other. Therefore, a listener assigned to each band can obtain a side localization effect at an assigned band.

Further, generally, in the case of a wide-band signal such as a music signal, it is difficult to divide and hear such signal for each band, and by a side localization effect at an assigned band, a listener feels as if a sound image is localized at a side for all frequency bands.

Thus, according to the sound image localization processing apparatus 100 of the present embodiment, by assigning each listener to each band of surround signal, producing a control signal so that each listener can obtain a side localization effect for his band, combining a surround signal with the control signal, and controlling a phase of surround signal, a plurality of listeners can sufficiently experience a side localization effect.

Here, in order to give a side localization effect to a plurality of listeners in a good balance, a method of assigning each seat (a center seat, a left seat, and a right seat) after a surround signal has been band-divided will be described.

First, for a sound signal, if a lot of time variations occur for each predetermined frequency band, a sense of localization is weakened, a listener has a tendency not to sense a sound image localization effect, so it is better that a width of frequency band to be assigned to each seat is wide.

Further, in the case where a left surround signal for localizing a sound image at a left side of listener and a right surround signal for localizing a sound image at a right side of listener are assigned to a right seat and a left seat, respectively, both are contrasted processes. Therefore, particularly, in the case where the correlation between a left surround signal and a right surround signal is high, it is thought that both processes are cancelled with each other, so it is better that the same seat is assigned for the same frequency band.

Further, in the case where a right seat and a left seat are assigned to a low frequency band, a listener is apt to be affected by a wraparound of head. Further, a path for one control signal becomes long, so it is apt to be affected by a reflection at a room, and it is thought that since a control signal reaches an ear differently from a desired waveform, a side localization effect is weakened. Therefore, a left seat or a right seat should not be assigned to a low frequency band (for example, equal to or lower than 400 Hz), and it is better that a center seat is assigned.

Further, in the case where a right seat and a left seat are assigned to a high frequency band, it is generally known that a level difference gives a big effect to localization in a high frequency band, so it is thought that it can become to a factor of much lowering a side localization effect at a different seat. Therefore, considering a balance of each seat, it is better that a high frequency band (for example, equal to or higher than 2,500) is assigned to a center seat.

Now, a specific setting of cut-off frequency at the time when a surround signal is divided by a predetermined band, and each seat is assigned to each band, will be described with reference to FIG. 4. FIG. 4 is an example showing the relationship between a position where a speaker is disposed and a seat position of a listener.

First, the relationship between a front speaker and a listening position of listener will be described.

Sound with a frequency band outputted from the front speaker 132 reaches a listening position of listener as a wave of wavelength. At this time, in the case where a side localization effect is given to a listener at the center seat 15a, interference between a surround signal and a control signal is utilized to produce a dip of sound pressure at the sides of both ears Therefore, when a thought is given to each frequency, this dip of sound pressure appears cyclically at a position where a time difference between a surround signal and a control signal becomes to an integral multiple of cycle of signal (see Equation 1). Therefore, when a cycle coincides with a time lag of arriving time due to a shift of seat, a listener can obtain the same side localization effect, even if a seat position is different.

On the other hand, at a position where a time difference between a surround signal and a control signal becomes to an integral multiple of cycle of signal+a half cycle, sound signals are cancelled with each other, and a dip of sound pressure does not occur, so a listener cannot obtain a side localization effect (see Equation 2).

For example, as shown in FIG. 4, assuming that listeners sit in a center seat, a right seat, and a left seat side-by-side, and experience an effect, an effect which a processing at the center seat gives to the other seats will be described. Here, Dl, Dr denote distances from a right seat to front speakers FL, FR, respectively.

a time difference between a surround signal produced from each front speaker at a right seat and a control signal is denoted as follows:

|Dl−Dr|/c

where c is the speed of sound.

Since it is thought that a frequency where this value becomes to an integral multiple of cycle can also produce a side localization effect at a right seat, a frequency which fulfills the following can also produce a side localization effect at a right seat, and an effect can be also obtained at a left seat due to symmetry.

|Dl−Dr|/c=1/f*n(n=1, 2, 3, . . . ) (Equation 1)

Further, even if a side localization processing is performed at a right seat or a left seat, a side localization effect can be obtained at all other seats by the same calculation.

On the other hand, a frequency which fulfills the following acts in such a way that sounds are cancelled with each other, so an effect cannot be obtained at a right seat and a left seat.

|Dl−Dr|/c=1/f*(n+1/2)(n=0, 1, 2, 3, . . . ) (Equation 2)

These frequencies and their cycles can produce an effect at every other seat in the case where a position of seat is considered. Therefore, if a processing is not performed at a center seat, and a processing is performed at a right seat (or a left seat), instead of the fact that an effect cannot be obtained at a center seat, an effect can be obtained at a left seat (or a right seat). Therefore, it is thought that at these frequency bands, if a processing is performed at a right seat (or a left seat), an effect can be obtained at many seats.

Now, based on an thought about the relationship between a front speaker and a listening position of a listener mentioned above, a specific example of setting a cut-off frequency will be described with reference to FIG. 4. In FIG. 4, listeners sit in a center seat, a right seat, and a left seat, respectively. Here, for example, an example of setting a cut-off frequency at the time when a band is divided into four bands by an LPF (low pass filter), a BPF (band pass filter), and an HPF (high pass filter) will be described.

According to Equation 1, in the case of n=1, a frequency is calculated as 1,000 Hz. Here, because of n=1, 2, 3, . . . , it can be seen that it is possible that a processing is performed at any seat, for example, around 1,000 Hz, 2,000 Hz.

On the other hand, according to Equation 2, in the case of n=0, a frequency is calculated as 500 Hz. Here, because of n=0, 1, 2, 3, . . . , it can be seen that it is better that a processing is performed at a right seat or a left seat, for example, around 500 Hz, 1,500 Hz.

Further, since it is thought that it is better that a low-frequency band or a high-frequency band is assigned to a center seat, and a middle-frequency band is assigned to a right seat or a left seat, it is better that center frequencies of two BPFs are set to be 500 Hz, and 1,500 Hz. Under this condition, it is thought that it is more effective that cut-off frequencies of filters of the two BPFs are set to have the same octave band width.

Now, a specific structure and a specific process of each device in a sound image localization processing apparatus according to the present embodiment will be described with reference to FIG. 1.

The sound source outputting device 110 is composed of, for example, a reproduction device for medium such as CD (Compact Disc) or DVD (Digital Versatile Disc), or a receiving device which receives a digital television broadcast signal. By reproducing a sound source such as CD, or by obtaining a broadcast sound source, an audio signal for each channel corresponding to 5.1 ch is outputted in the form of digital signal to the signal processing device 120.

An audio signal for each channel outputted from the sound source outputting device 110 is supplied to the signal processing device 120. The signal processing device 120 is arranged to include an input processing unit 121 which receives an audio signal supplied from the sound source outputting device 110, a signal processing unit 200 which signal-processes the audio signal for each channel, D/A converters 122FL 122FR each of which converts an audio signal composed of digital signal signal-processed for each channel to an analogue signal, and power amplifiers 123FL, 123FR which amplify an audio signal converted to an analogue signal for each channel.

Under the control of a system control unit 125, the signal processing unit 200 controls a phase of surround signal to be supplied to a surround speaker, produces a control signal for localizing a sound image at a side of listener, and adds the control signal to a surround signal and outputs the resultant. So that the surround signal to which the control signal has been added is supplied to the FL speaker and the FR speaker, such surround signal is supplied to the D/A converters 122FL, 122FR.

Further, under the control of the system control unit 125, the power amplifier 123 amplifies a signal level of audio signal for each channel according to an indication of volume indicated by an operation unit 124, and outputs each amplified audio signal to the FL and the FR speakers corresponding to the respective channels.

The operation unit 124 is composed of a remote control unit including a variety of confirmation buttons and selection buttons, and a plurality of keys such as numeric keys, or a variety of key buttons.

The system control unit 125 is arranged to generally control the whole function for causing the FL and FR speakers to output an audio signal, and performing a sound image localization process for a plurality of listeners.

Here, a channel denotes a path for signal-transmitting an audio signal outputted from the sound source outputting device 110, and each channel is arranged to transmit an audio signal basically different from another channel.

Now, a side localization process in a specific signal processing unit will be described.

### Embodiment No. 1

Now, an embodiment of signal processing unit in the case where listeners exist in a center seat and a right seat will be described with reference to FIGS. 5 and 6. FIG. 5 is a diagram showing a flow of a surround signal to be supplied to a left speaker in a signal processing unit according to the present embodiment No. 1. FIG. 6 is a diagram showing a flow of a surround signal to be supplied to a right speaker in a signal processing unit according to the present embodiment No. 1.

In the present embodiment, a surround signal to be supplied to a surround speaker is divided into a low-frequency band and a high-frequency band, a center seat and a right seat are assigned to the respective divided bands, and a side localization process is performed for a listener at each seat which has been assigned to each band. In the present embodiment, a low-frequency band is assigned to a center seat, and a high-frequency band is assigned to a right seat.

In the signal processing unit 200 in the present embodiment, first, as shown in FIG. 5, a left surround signal SL which functions as a left signal to be outputted to the left surround speaker 135 is divided into a surround signal to be supplied to a FL speaker (hereinafter, referred to as “a surround signal SLL to be supplied to a left speaker”), and a surround signal to be supplied to a FR speaker (hereinafter, referred to as “a surround signal SLR to be supplied to a right speaker”).

A frequency band of the surround signal SLL to be supplied to a left speaker is divided into a low-frequency band and a high-frequency band by an LPF and an HPF, and then, a level of the surround signal corresponding to a high-frequency band is corrected (adjusted) so that a band is flattened and a level of sound pressure is equal. A surround signal whose frequency band has been divided is mixed and outputted.

On the other hand, the surround signal SLR to be supplied to a right speaker produces an appropriate time difference at each frequency band, and is phase-controlled so that a sound image is localized at a side of listener in a center seat by an all-pass filter which can change only a phase without changing a amplitude value of each frequency. After that, a frequency band of the surround signal SLR is divided into a low-frequency band and a high-frequency band by an LPH and an HPF, and a delay and attenuation process is performed so that a sound image is localized at a side of listener in a right seat for a surround signal corresponding to a high-frequency band. A level of the surround signal corresponding to a high-frequency band is adjusted so that a level of sound pressure becomes equal to flatten a band. A surround signal whose band has been divided is mixed and outputted. It is possible that a phase-control process is performed by a combination of a band-division filter bank and a delay element.

Further, in the signal processing unit 200, as shown in FIG. 6, a right surround signal SR which functions as a right signal to be outputted to the right surround speaker 135 is divided into a surround signal to be supplied to a FR speaker (hereinafter, referred to as “a surround signal SRR to be supplied to a right speaker”), and a surround signal to be supplied to a FL speaker (hereinafter, referred to as “a surround signal SRL to be supplied to a left speaker”).

A frequency band of the surround signal SRR to be supplied to a right speaker is divided into a low-frequency band and a high-frequency band by an LPF and an HPF, and then, a surround signal corresponding to a high-frequency band is delay-processed and attenuation-processed so that a sound image is localized at a side of listener in a right seat. A level of surround signal corresponding to a high-frequency band is adjusted so that a band is flattened and a level of sound pressure is equal. A surround signal whose frequency band is different is mixed and outputted.

On the other hand, the surround signal SRL to be supplied to a left speaker is phase-controlled so that a sound image is localized at a side of listener in a center seat, and then, a frequency band of the surround signal SRL is divided into a low-frequency band and a high-frequency band by an LPF and an HPF, and a level of the surround signal corresponding to a high-frequency band is adjusted so that a band is flattened and a level of sound pressure is equal. A surround signal whose frequency band is different is mixed and outputted.

The surround signals SLR and SRR to be supplied to a right speaker are mixed with each other, and supplied as aright surround signal to a FR speaker. The surround signals SLL and SRL to be supplied to a left speaker are mixed with each other, and supplied as a left surround signal to a FL speaker.

In the present embodiment, a phase of surround signal is controlled so that a listener in a center seat can obtain a side localization effect at a low-frequency band, and a listener in a right seat can obtain a side localization effect at a high-frequency band. With this arrangement, a listener in each seat can experience a side localization effect.

In the present embodiment, a frequency band to be band-divided is the same for a left surround signal and a right surround signal. However, it is possible that the frequency band is different. For example, it is possible that a frequency to be band-divided for a left surround signal is set to be 400 Hz, and a frequency to be band-divided for a right surround signal is set to be 1 kHz.

### Embodiment No. 2

Now, an embodiment of signal processing unit in the case where listeners exist in a center seat, a right seat, and a left seat will be described with reference to FIGS. 7 and 8. FIG. 7 is a diagram showing a flow of a surround signal to be supplied to a left speaker in a signal processing unit according to the present embodiment No. 2. FIG. 8 is a diagram showing a flow of a surround signal to be supplied to a right speaker in a signal processing unit according to the present embodiment No. 2.

In the present embodiment, a surround signal to be supplied to a surround speaker is divided into a low-frequency band, a middle-frequency band, and a high-frequency band, and a center seat, a right seat, and a left seat are assigned to the respective divided bands, and a side localization process is performed for a listener at each seat which has been assigned to each band. In the present embodiment, a low-frequency band is assigned to a center seat 15a, a middle-frequency band is assigned to a right seat 15b, and a high-frequency band is assigned to a left seat 15c.

In the signal processing unit 200 in the present embodiment, first, as shown in FIG. 7, a left surround signal SL to be outputted to a left surround speaker is divided into a surround signal SLL to be supplied to a left speaker, and a surround signal SLR to be supplied to a right speaker.

A frequency band of the surround signal SLL to be supplied to a left speaker are divided into a low-frequency band, a middle-frequency band, and a high-frequency band by an LPF, a BPF, and an HPF, and then, the surround signal SLL is delay-processed and attenuation-processed so that a sound image is localized at a side of listener in a left seat for a surround signal corresponding to a high-frequency band. A level of the surround signal corresponding to a middle-frequency band and a high-frequency band is corrected (adjusted) so that a band is flattened and a level of sound pressure is equal. A surround signal whose band has been divided is mixed and outputted.

On the other hand, the surround signal SLR to be supplied to a right speaker is phase-controlled by an all-pass filter so that a sound image is localized at a side of listener in a center seat. After that, a frequency band of the surround signal SLR is divided into a low-frequency band, a middle-frequency band, and a high-frequency band by an LPF, a BPF, and an HPF, and a delay and attenuation process is performed so that a sound image is localized at a side of listener in a right seat for a surround signal corresponding to a middle-frequency band. A level of the surround signal corresponding to a middle-frequency band and a high-frequency band is adjusted so that a band is flattened and a level of sound pressure is equal. A surround signal whose band has been divided is mixed and outputted.

Further, in the signal processing unit 200, as shown in FIG. 7, a surround signal SR to be outputted to a right surround speaker is divided into a surround signal SRR to be supplied to a right speaker, and a surround signal SRL to be supplied to a left speaker.

A frequency band of the surround signal SRR to be supplied to a right speaker is divided into a low-frequency band, a middle-frequency band, and a high-frequency band by an LPF, a BPF, and an HPF, and then, the surround signal corresponding to a middle-frequency band is delay-processed and attenuation-processed so that a sound image is localized at a side of listener in a right seat. A level of surround signal corresponding to a middle-frequency and a high-frequency band is adjusted so that a band is flattened and a level of sound pressure is equal. A surround signal whose frequency band has been divided is mixed and outputted.

On the other hand, the surround signal SRL to be supplied to a left speaker is phase-controlled by an all-pass filter so that a sound image is localized at a side, of listener in a center seat, and then, a frequency band of the surround signal is divided into a low-frequency band, a middle-frequency band, and a high-frequency band by an LPF, a BPF, and an HPF, and the surround signal corresponding to a high-frequency band is delay-processed and attenuation-processed so that a sound image is localized at a side of listener in a left seat. A level of the surround signal corresponding to a middle-frequency band and a high-frequency band is adjusted so that a band is flattened and a level of sound pressure is equal. A surround signal whose frequency band has been divided is mixed and outputted.

The surround signals SLR and SRR to be supplied to a right speaker are mixed with each other, and supplied as a right surround signal to a FR speaker. The surround signals SLL and SRL to be supplied to a left speaker are mixed with each other, and supplied as a left surround signal to a FL speaker.

In the present embodiment, a phase of surround signal is controlled so that a listener in a center seat can obtain a side localization effect at a low-frequency band, a listener in a right seat can obtain a side localization effect at a middle-frequency band, and a listener in a left seat can obtain a side localization effect at a high-frequency band. With this arrangement, a listener in each seat can experience a side localization effect.

### Embodiment No. 3

Now, an embodiment of signal processing unit in the case where listeners exist in a center seat and a right seat will be described with reference to FIGS. 9 and 10. FIG. 9 is a diagram showing a flow of a surround signal to be supplied to a left speaker in a signal processing unit according to the present embodiment No. 3. FIG. 10 is a diagram showing a flow of a surround signal to be supplied to a right speaker in a signal processing unit according to the present embodiment No. 3.

In the present embodiment, a surround signal to be supplied to a surround speaker is divided into a low-frequency band, a middle-band, and a high-frequency band. A low-frequency band and a high-frequency band are assigned to a center seat, and a middle-frequency band is assigned to a right seat. A side localization process is performed for a listener at each seat which has been assigned to each band.

In the signal processing unit 200 in the present embodiment, first, as shown in FIG. 9, a left surround signal SL to be outputted to a left surround speaker is divided into a surround signal to be supplied to a surround signal SLL to be supplied to a left speaker, and a surround signal SLR to be supplied to a right speaker.

A frequency band of the surround signal SLL to be supplied to a left speaker is divided into a low-frequency band, a middle-frequency band, and a high-frequency band by an LPF, a BPF, and an HPF, and then, a level of the surround signal corresponding to a middle-frequency band is adjusted so that a band is flattened and a level of sound pressure is equal. A surround signal whose frequency band has been divided is mixed and outputted.

On the other hand, the surround signal SLR to be supplied to a right speaker is phase-controlled so that a sound image is localized at a side of listener in a center seat by an all-pass filter. After that, a frequency band of the surround signal SLR is divided into a low-frequency band, a middle-frequency band, and a high-frequency band by an LPH, a BPF, and an HPF, and a delay and attenuation process is performed so that a sound image is localized at a side of listener in a right seat for a surround signal corresponding to a middle-frequency band. A level of the surround signal corresponding to a middle-frequency band is adjusted so that a frequency band is flattened, and a level of sound pressure is equal. A surround signal whose frequency band has been divided is mixed and outputted.

Further, in the signal processing unit 200, as shown in FIG. 10, a surround signal SR to be outputted to a right surround speaker is divided into a surround signal SRR to be supplied to a right speaker, and a surround signal SRL to be supplied to a left speaker.

A frequency band of the surround signal SRR to be supplied to a right speaker is divided into a low-frequency band, a middle-frequency band, and a high-frequency band by an LPF, a BPF, and an HPF, and then, the surround signal corresponding to a middle-frequency band is delay-processed and attenuation-processed so that a sound image is localized at a side of listener in a right seat. A level of surround signal corresponding to a middle-frequency band is adjusted so that a band is flattened and a level of sound pressure is equal. A surround signal whose frequency band has been divided is mixed and outputted.

On the other hand, the surround signal SRL to be supplied to a left speaker is phase-controlled by an all-pass filter so that a sound image is localized at a side of listener in a center seat, and then, a frequency band of the surround signal is divided into a low-frequency band, a middle-frequency band, and a high-frequency band by an LPF, a BPF, and an HPF, and a level of the surround signal corresponding to a middle-frequency band is adjusted so that a band is flattened and a level of sound pressure is equal. A surround signal whose frequency band has been divided is mixed and outputted.

The surround signals SLR and SRR to be supplied to a right speaker are mixed with each other, and supplied as a right surround signal to a FR speaker. The surround signals SLL and SRL to be supplied to a left speaker are mixed with each other, and supplied as a left surround signal to a FL speaker.

In the present embodiment, considering that it is effective that a low-frequency band and a high-frequency band are assigned to a center seat, and a middle-frequency band is assigned to a right seat or a left seat, a phase of surround signal is controlled so that a listener in a center seat can obtain a side localization effect at a low-frequency band and a high-frequency band, and a listener in a right seat can obtain a side localization effect at a middle-frequency band. With this arrangement, a listener in each seat can experience an enough side localization effect.

### Embodiment No. 4

Now, an embodiment of signal processing unit in the case where listeners exist in a center seat, a right seat, and a left seat will be described with reference to FIGS. 11 and 12. FIG. 11 is a diagram showing a flow of a surround signal to be supplied to a left speaker in a signal processing unit according to the present embodiment No. 4. FIG. 12 is a diagram showing a flow of a surround signal to be supplied to a right speaker in a signal processing unit according to the present embodiment No. 4.

In the present embodiment, a surround signal to be supplied to a surround speaker is divided into a low-frequency band, two middle-frequency bands, and a high-frequency band, and a center seat is assigned to a low-frequency band and a high-frequency band, and a right seat and a left seat are assigned to the two middle-frequency bands, and a side localization process is performed for a listener at each seat which has been assigned to each band. In the present embodiment, a lower middle-frequency band is assigned to a right seat, and a higher middle-frequency band is assigned to a left seat 15.

In the signal processing unit 200 in the present embodiment, first, as shown in FIG. 11, a left surround signal SL to be outputted to a left surround speaker is divided into a surround signal SLL to be supplied to a left speaker, and a surround signal SLR to be supplied to a right speaker.

A frequency band of the surround signal SLL to be supplied to a left speaker are divided into a low-frequency band, two middle-frequency bands, and a high-frequency band by an LPF, a BPF1, a BPF2, and an HPF, and then, the surround signal SLL is delay-processed and attenuation-processed so that a sound image is localized at a side of a listener in a left seat for a surround signal corresponding to a higher middle-frequency band. A level of the surround signal corresponding to two different middle-frequency bands is adjusted so that a band is flattened and a level of sound pressure is equal. A surround signal whose frequency band has been divided is mixed and outputted.

On the other hand, the surround signal SLR to be supplied to a right speaker is phase-controlled by an all-pass filter so that a sound image is localized at a side of listener in a center seat. After that, a frequency band of the surround signal SLR is divided into a low-frequency band, two middle-frequency bands, and a high-frequency band by an LPF, a BPF1, a BPF2, and an HPF, and a delay and attenuation process is performed so that a sound image is localized at a side of listener in a right seat for a surround signal corresponding to a lower middle-frequency band. A level of the surround signal corresponding to two different middle-frequency bands and a high-frequency band is adjusted so that a band is flattened and a level of sound pressure is equal. A surround signal whose frequency band has been divided is mixed and outputted.

Further, in the signal processing unit 200, as shown in FIG. 12, a surround signal SR to be outputted to a right surround speaker is divided into a surround signal SRR to be supplied to a right speaker, and a surround signal SRL to be supplied to a left speaker.

A frequency band of the surround signal SRR to be supplied to a right speaker are divided into a low-frequency band, two middle-frequency bands, and a high-frequency band by an LPF, a BPF1, a BPF2, and an HPF, and then, the surround signal corresponding to a lower middle-frequency band is delay-processed and attenuation-processed so that a sound image is localized at a side of listener in a right seat. A level of surround signal corresponding to two different middle-frequency bands is adjusted so that a band is flattened and a level of sound pressure is equal. A surround signal whose frequency band has been divided is mixed and outputted.

On the other hand, the surround signal SRL to be supplied to a left speaker is phase-controlled by an all-pass filter so that a sound image is localized at a side of listener in a center seat, and then, a frequency band of the surround signal is divided into a low-frequency band, two middle-frequency bands, and a high-frequency band by an LPF, a BPF1, a BPF2, and an HPF, and the surround signal corresponding to a higher middle-frequency band is delay-processed and attenuation-processed so that a sound image is localized at a side of listener in a left seat. A level of the surround signal corresponding to two different middle-frequency bands is adjusted so that a band is flattened and a level of sound pressure is equal. A surround signal whose frequency band has been divided is mixed and outputted.

The surround signals SLR and SRR to be supplied to a right speaker are mixed with each other, and supplied as a right surround signal to a FR speaker. The surround signals SLL and SRL to be supplied to a left speaker are mixed with each other, and supplied as a left surround signal to a FL speaker.

In the present embodiment, considering that it is effective that a low-frequency band and a high-frequency band are assigned to a center seat, and a middle-frequency band is assigned to a right seat or a left seat, a phase of surround signal is controlled so that a listener in a center seat can obtain a side localization effect at a low-frequency band and a high-frequency band, a listener in a right seat can obtain a side localization effect at a higher middle-frequency band, and a listener in a left seat can obtain a side localization effect at a lower middle-frequency band. With this arrangement, a listener in each seat can experience an enough side localization effect.

The present invention is not confined to the embodiments mentioned above, but the present invention can be performed in a variety of modes. For example, a width of middle-frequency band at the time when a frequency band is divided can be freely set, as long as an energy balance of right and left is put in order. It is possible that this band is further divided by an octave band filter as compared with the embodiment, and a right seat and a left seat are assigned alternately. Further, Since localization of sound image for listeners in a right seat and a left seat is considerably different in a position where a listener is to sit, it is possible that a delay and attenuation process is freely set at a side of listener. Further, a sound image localization processing apparatus described in the embodiment can be applied to a home theater system, a slim-type television set such as a PDP (plasma display panel), a PC (personal computer), and a personal surround system such as a portable DVD (digital versatile disc) player.

1-5. (canceled)

6. A sound image localization processing apparatus, which causes two speakers disposed at the right and the left in front of a listener to output sound in accordance with a plurality of supplied sound signals, and localizes a sound image at a side of a plurality of listeners,
the sound image localization processing apparatus, comprises:
a signal processing device which controls a phase of a right signal indicative of sound signal which should be heard from the right side, and a left signal indicative of sound signal which should be heard from the left side, relative to a listening position of one of the listeners, and localizing a sound image at a side of one of the listeners
a frequency-band division device which divides the processed sound signal by a predetermined frequency band, and
a signal correction device which assigns each listener to the divided frequency band, controlling a phase of the right signal or the left signal which has been signal-processed for a listening position of the other listener, and localizing a sound image at a side of the other listener,
wherein the listeners are disposed side-by-side opposite the two speakers, and the listeners includes a listener in a center seat for which distances to the two speakers are set to be the same as each other, and a listener in a right seat or a left seat disposed on a right side or a left side thereof,
a frequency band to be divided by the frequency-band division means is divided into a low-frequency band, a middle-frequency band, and a high-frequency band, and
a phase of the right signal or the left signal is controlled so that a side localization effect is given to a listener in the center seat at the low frequency band and the high frequency band, and a phase of the right signal or the left signal is controlled so that a side localization effect is given to a listener in the right seat or the left seat at the middle frequency band.

7. A sound image localization processing apparatus according to claim 6,
wherein a frequency band to be divided by the frequency-band division device is set in such a way that a frequency at which a dip of sound pressure calculated on the basis of the location of the two speakers and a listening position of listener does not occur is set as a center frequency, and
a phase of the right signal or the left signal is controlled so that a side localization effect is given to a listener in the right seat or the left seat at the frequency band.

8. A sound image localization processing method, of causing two speakers disposed at the right and the left in front of a listener to output sound in accordance with a plurality of supplied sound signals, and localizing a sound image at a side of a plurality of listeners,
the sound image localization processing method, comprises:
a signal processing process of controlling a phase of a right signal indicative of sound signal which should be heard from the right side, and a left signal indicative of sound signal which should be heard from the left side, relative to a listening position of one of the listeners, and localizing a sound image at a side of one of the listeners,
a frequency-band division process of dividing the processed sound signal by a predetermined frequency band, and
a signal correction process of assigning each listener to the divided frequency band, controlling a phase of the right signal or the left signal which has been signal-processed for a listening position of the other listener, and localizing a sound image at a side of the other listener,
wherein the listeners are disposed side-by-side opposite the two speakers, and the listeners includes a listener in a center seat for which distances to the two speakers are set to be the same as each other, and a listener in a right seat or a left seat disposed on a right side or a left side thereof,
a frequency band to be divided by the frequency-band division means is divided into a low-frequency band, a middle-frequency band, and a high-frequency band, and
a phase of the right signal or the left signal is controlled so that a side localization effect is given to a listener in the center seat at the low frequency band and the high frequency band, and a phase of the right signal or the left signal is controlled so that a side localization effect is given to a listener in the right seat or the left seat at the middle frequency band.

9. A computer-readable medium in which a sound image localization processing program is recorded, said program causing a computer included in a sound image localization processing apparatus according to claim 6 to function as:
a signal processing device which controls a phase of a right signal indicative of sound signal which should be heard from the right side, and a left signal indicative of sound signal which should be heard from the left side, relative to a listening position of one of the listeners, and localizing a sound image at a side of one of the listeners,
a frequency-band division device which divides the processed sound signal by a predetermined frequency band, and
a signal correction device which assigns each listener to the divided frequency band, controlling a phase of the right signal or the left signal which has been signal-processed for a listening position of the other listener, and localizing a sound image at a side of the other listener,
wherein the listeners are disposed side-by-side opposite the two speakers, and the listeners includes a listener in a center seat for which distances to the two speakers are set to be the same as each other, and a listener in a right seat or a left seat disposed on a right side or a left side thereof,
a frequency band to be divided by the frequency-band division means is divided into a low-frequency band, a middle-frequency band, and a high-frequency band, and
a phase of the right signal or the left signal is controlled so that a side localization effect is given to a listener in the center seat at the low frequency band and the high frequency band, and a phase of the right signal or the left signal is controlled so that a side localization effect is given to a listener in the right seat or the left seat at the middle frequency band.
